(19) United States
(12) Patent Application Publication
(10) Pub. No.: US 2003/0044050 A1
(43) Pub. Date: Mar. 6, 2003

(54) System and method for biometric identification and response

(75) Inventors: David Kingsley Clark, Cedar Park, TX (US); Julie Louise Gilbreath, Liberty Hill, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 09/941,249

(22) Filed: Aug. 28, 2001

(51) Int. Cl. H04Q 1/00; G06K 9/00; G06K 9/68; H04B 1/00; H04B 3/00; G06F 7/00; G06F 7/04; H04Q 9/00; G05B 19/00; G08C 19/00; G05B 23/00; G08B 29/00

(52) U.S. Cl. 382/115; 382/218; 340/5.82

(57) ABSTRACT

A system and method for biometric identification and response is presented. Raw biometric data is received by a biometric acquisition system. The biometric acquisition system generates a digital signature based on the raw biometric data. The digital signature is compared to a biometric action data list to find a match. If a match is found, a message is sent to one or more recipients based on who the identified person is. The message can be customized and include a current photo of the identified person and the location as to where the identified person is spotted. The message may be encrypted and also include a digital signature of the sender in order for the recipient to verify the sender of the message.

### BACKGROUND OF THE INVENTION

1. Technical Field

The present invention relates in general to a method and system for sending messages based on where an individual is located. More particularly, the present invention relates to a system and method for identifying individuals through biometric identification and sending a message corresponding to the individual's profile.

2. Description of the Related Art

Being able to identify individuals from crowds of people has many advantages. For example, it may be desirable to identify valuable customers entering a department store and making sure they served promptly. Historically this is a manual process in which individuals, such as a store clerk, have the knowledge needed to identify important customers. In the example described above, a sales person may require to have past experience with the particular customer in order to know that the customer frequents the department store and buys many items. A challenge found is that if a new sales person is not aware of the valued customer, the valued customer may get frustrated with the lack of attention and may not return to the store.

Another example of manually identifying individuals is finding criminals, missing persons, and other wanted individuals. Police officers watch a particular area, searching for the criminal. A challenge during a stakeout is identifying the criminal if the criminal makes minor changes to his appearance, such as changing the color of his hair. The public may be asked to help identify and find certain individuals and report any findings to the police. Being a manual and human-intensive activity, the police often receive numerous erroneous calls from well intentioned citizens. Substantial amounts of police time are used to investigate such erroneous reports.

In addition, an individual may want to be recognized and receive certain information when he enters a location. For example, one customer may always want to know what promotions are being offered at his favorite department store, while another customer may want to know whether a hard-to-find item is currently in stock in each of the stores that he enters. Using a manual approach, the first customer locates promotional material, if available, and peruses the material to identify products of interest. Using a manual approach, the second customer may talk to store clerks, customer service, or other information sources in each of the stores he enters. A challenge with the prior art, therefore, is recognizing an individual and providing him with information that he is seeking.

Biometric technology is being developed that digitizes a person's features, such as facial structure, and matched against a list of individual profiles. In the example described above, biometric technology may be able to identify a criminal if the criminal changes the color of his hair. However, biometric technology is currently used in conjunction with manual systems, such as displaying a matched image on a user's display console. The user, in turn, determines how to respond when a matched image is displayed. In addition, biometric matching technology is typically constrained to a particular location, such as identifying people in an auditorium. In the example described above, law enforcement first selects a given location where they suspect that the wanted individual may appear. A challenge found with existing art is the lack of end-to-end architecture that offers an automated identification system with a flexible and secure means to disseminate messages.

What is needed, therefore, is a system that is flexible in terms of identifying individuals in a variety of locations and flexible in taking a variety of actions in response to identifying an individual.

### SUMMARY

It has been discovered that by using an architecture that includes a biometric acquisition system and a communication system, messages may be sent to one or more recipients that are based upon unique characteristics of an individual and the individual's identified location.

A biometric acquisition system (hardware and software) is used to identify people in public areas. Identification may be by a camera image, voice recognition, etc. For example, facial recognition techniques identify characteristics of a person's face through sampling points. These various points are aggregated and hashed into a face attribute value that is used to identify a person in a biometric data action list that includes the person's unique biometric signature. Other types of biometric sampling can be used, such as a voiceprint match.

With the face attribute, the implementing architecture checks each biometric signature in the biometric signature database to match the hashed face attribute against the value of a stored biometric signature in the database. If the values match, this architecture may have found the record of the person to whom the biometric signature belongs. The speed of workstations makes searches over large databases feasible. With a possible match, the architecture utilizes a communications system to send a message to a recipient.

First, the architecture prepares a message to the recipient using rules established by the administrator. For example, the message may be customized for the recipient, depending who the recipient is and the location at which the recipient is identified. Next, the architecture extracts the recipient's public key from the matching record. The architecture uses the Public Key Cryptography Standards (PKCS) to sign the message using the implementing architecture's private key. The architecture then encrypts the signed message (contents and signature) with the recipient's public key. With the signed and encrypted message constructed, the architecture broadcasts the message to the recipient. For example, if a person enters a shopping mall and is identified, a wireless message may be sent to his handheld device capable of receiving the message, such as a personal digital assistant (PDA), notifying him of the promotions being offered in the mall.

The recipient receives the wireless message with a device. The recipient uses his private key to decipher the message and get the message contents and signature. The recipient verifies the sender's signature using the sender's public key that is obtained from a trusted third party. With the message deciphered and sender's signature verified, the recipient views the message that was sent. If the visual match is not correct, the architecture encrypts the message with a different public key and the recipient is not able to decipher the message properly. Optionally, the architecture may not sign the message and may just send an encrypted message to the recipient. However, the recipient is not able to verify who sent the message. In addition, the architecture may be designed to sign the message but not encrypt the message. However, the message content will not be secure when it is transmitted.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a high-level diagram showing a biometric acquisition system identifying an individual and sending a message through a communications network;

FIG. 2 is a flowchart showing biometric sensors capturing biometric data and processing the information;

FIG. 3 is a flowchart showing a message being prepared based on biometric processing results;

FIG. 4 is a flowchart showing a message being sent based on biometric processing results;

FIG. 5 is a flowchart showing a recipient receiving a message resulting from biometric data processing; and

FIG. 6 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

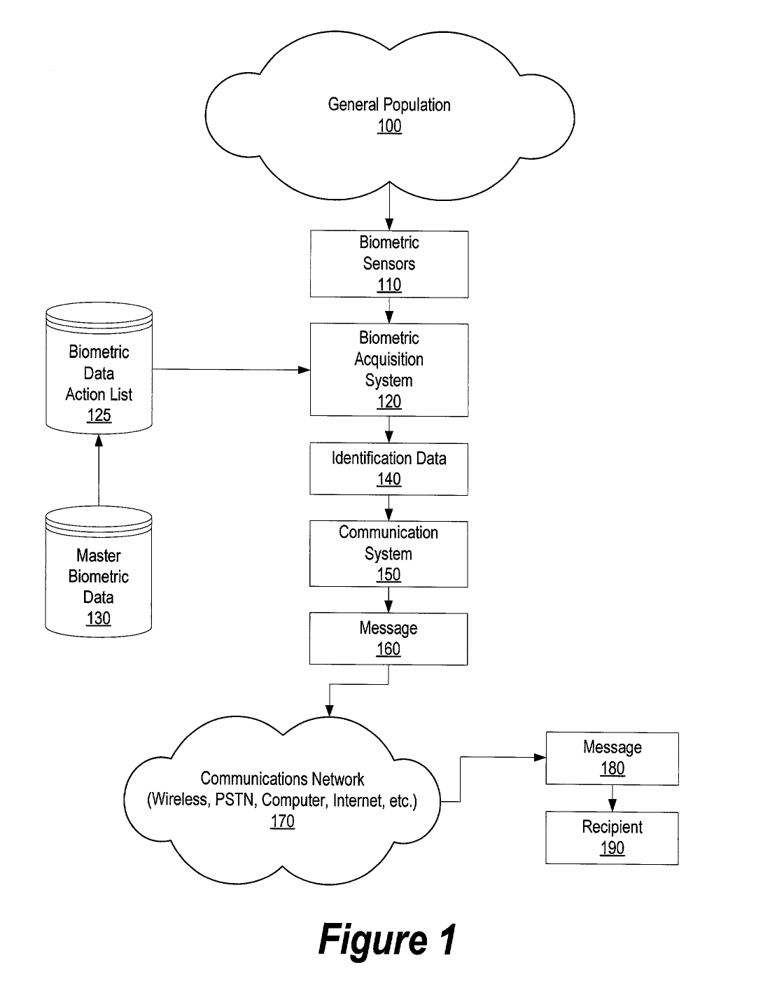

FIG. 1 is a high-level diagram showing a biometric acquisition system identifying an individual and sending a message through a communications network. General population 100 includes individuals at various locations. For example, general population 100 may be people in a mall, on public streets, in an auditorium, etc. Biometric sensors 110 capture raw data about general population 100. Biometric sensors 110 may include cameras, microphones, heat sensors, etc. For example, cameras may be installed to take images of people at various locations. Biometric sensors 110 sends raw data to biometric acquisition system 120. Biometric acquisition system 120 processes the raw data, and generates a signature. For example, the biometric acquisition system may receive pictures of individuals and generate a facial signature by sampling various points of the persons face, aggregating them, and hash them into a face attribute value.

Biometric acquisition system 120 retrieves information from biometric data action List 125 that includes biometric signatures of individuals that are currently being searched. Biometric data action list 125 is a subset of master biometric data 130 that includes a comprehensive list of biometric signatures. For example, master biometric data 130 may include all prisoners. If a prisoner escapes, master biometric data 130 uploads the biometric signature information of the escaped convict to biometric data action list 125 so the biometric acquisition system will actively search for the escaped prisoner. Biometric acquisition system 120 outputs identification data 140 that corresponds to an identified person. Identification data 140 includes information as to what information to send when the identified individual is found, and where the message should be sent.

For example, if an individual is recognized while entering a certain department store, he may have his identification data configured to download sale information relative to the department store he enters. Communication system 150 formats and sends the message corresponding to identification data 140. Communication system 150 sends message 160 to communications network 170 which may be a wireless system, a PSTN, a computer network such as the Internet, etc. Recipient 190 receives message 180 from computer network 170. Message 180 may include some form of action to be taken. For example, if a person is on parole and is not allowed to enter drinking establishments, the identified person could be sent a warning. A message may also be sent to the police alerting them of the situation. In addition, a telephone call could automatically be placed to the tavern so that the bartender could refuse to serve the identified person. Communication system 150 could also notify the bartender by sending a message to his PDA.

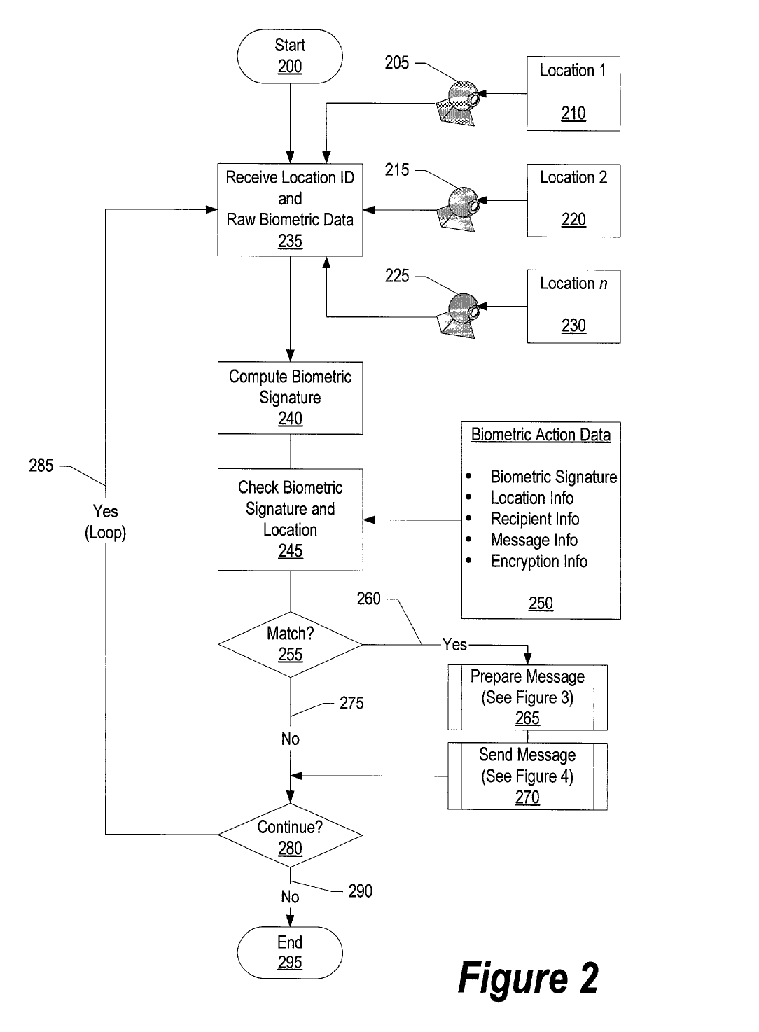

FIG. 2 is a flowchart showing biometric sensors capturing biometric data and processing the information. Processing commences at 200, whereupon a location ID and raw biometric data are received from biometric sensor 205, 215, and 225 (step 235). Biometric sensors 205 is positioned in an area to monitor location 1 210, biometric sensor 215 is positioned in an area to monitor location 2 220, and biometric sensor 225 is positioned in an area to monitor location n 230. Each location has an assigned ID so that the identity of the person can be tied to his correct location. Biometric sensors 205, 215, and 225 may be in a central location, such as a mall, or may be spread out across a city. For example, the biometric sensors may be capturing biometric data of patrons coming into drinking establishments throughout a city. The system may be watching for known DWI offenders that should not be in such establishments.

The output of biometric sensor 205, 215, and 225 is received at step 235, which includes the location id and the raw biometric data. The biometric signature is computed at step 240. For example, the biometric sensors may capture a person's facial characteristics, and a biometric signature is generated based on traits of such characteristics. A person's face generates a unique biometric signature. The biometric signature and location are compared with biometric signatures stored in biometric action data 250 (step 245). Biometric action data 250 includes biometric signatures of individuals that are actively being sought and is a subset of a population of biometric data. For example, biometric action data 250 may include wanted criminals in the country, along with people that have restraining orders against them. Biometric action data 250 includes a person's biometric signature who is being sought out, a list of locations being searched, contact information for one or more contacts, information to include or action to take in the message that will be sent to the contact person(s), and encryption information of the contact(s) in order to send a secure message.

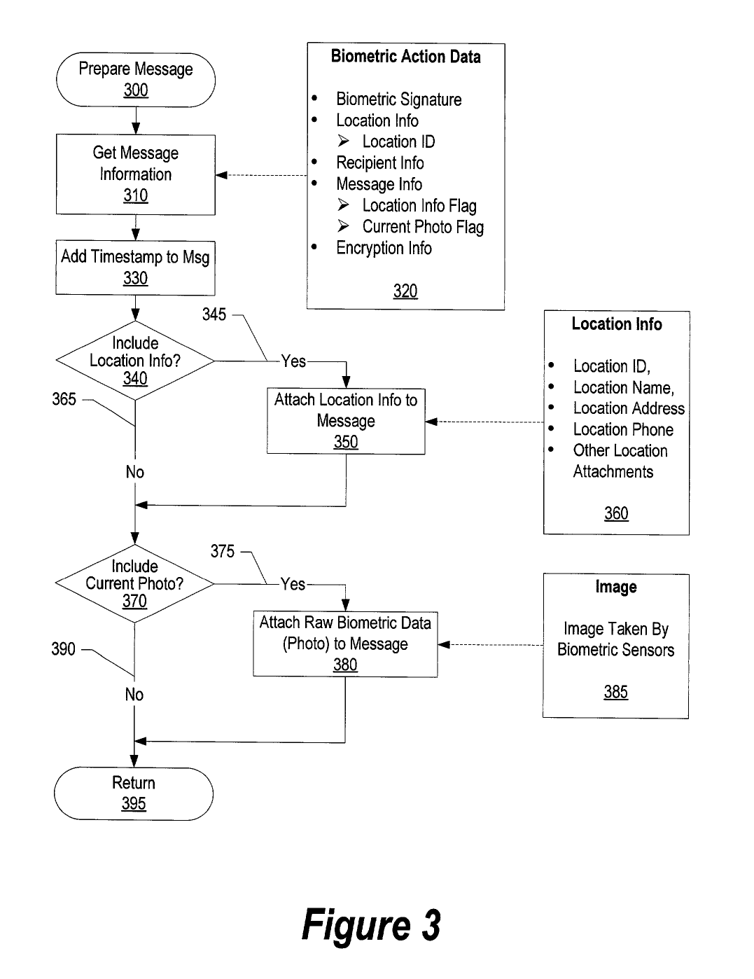

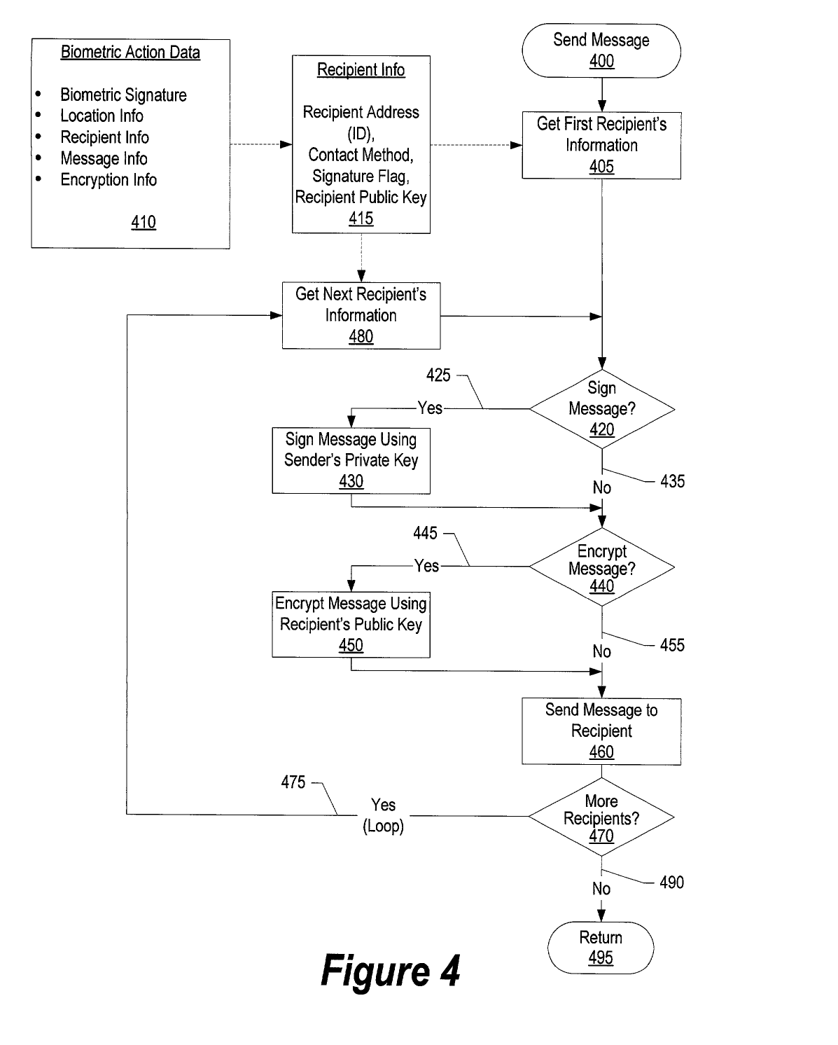

A determination is made as to whether the biometric signature in question matches a biometric signature found in biometric action data 250 (decision 255). If it is determined that there is not a match, decision 255 branches to “No” branch 275 whereupon no action is taken. On the other hand, if there is a match between the biometric signature in question and a biometric signature found in biometric action data 250, decision 255 branches to “Yes” branch 260 whereupon a message is prepared (pre-defined process block 265, see FIG. 3 for further details). The message is sent to one or more contacts corresponding to the biometric signature in biometric action data 250 (pre-defined process block 270, see FIG. 4 for further details). A determination is made as to whether processing should continue to monitor (decision 280). If processing is still monitoring, decision 280 branches to “Yes” branch 285 which loops back to receive another location ID and raw biometric data. This looping continues until monitoring is no longer desired, at which point decision 280 branches to “No” branch 290 and processing ends at 295.

FIG. 3 is a flowchart showing a message being prepared based on biometric processing results. Processing commences at 300, whereupon message information is retrieved from biometric action data 320 corresponding to the identified person (step 310). The information retrieved includes a location ID that identifies where the person was found. Biometric action data 320 also includes message information such as a location information flag and current photo flag. These flags may be selected to include the location information and a current photograph of the person. For example, if a missing or wanted person is found, a current photograph and location information may be sent to the local authorities. The current photograph may be obtained form the raw biometric image that was taken of the individual. A timestamp is added to the message to inform the recipient of the time at which the person was spotted (step 330).

A determination is made as to whether the location information is included in the message (decision 340). This determination is based on the setting of the location info flag for this particular person. If the location information flag is not selected, decision 340 branches to “No” branch 365. On the other hand, if the location flag is set, decision 340 branches to “Yes” branch 345 whereupon the location information is retrieved from location info 360 and attached to the message (step 350). Location info 360 includes information such as the location's ID, location name, location address, location phone number, and other location attachments such as the number of entrances.

A determination is made as to whether a photo is included in the message (decision 370). The determination is made based on the current photo flag setting. If the current photo flag is not set, decision 370 branches to “No” branch 390. On the other hand, if the current photo flag is set, decision 370 branches to “Yes” branch 375 whereupon current photo information is retrieved from image 380 and attached to the message. Image 380 is the image taken by the biometric sensors. The image may be filtered and cropped in order to send a better photograph of the individual. Processing subsequently returns at 395.

FIG. 4 is a flowchart showing a message being sent based on biometric processing results. Processing commences at 400, whereupon information about the first recipient to be notified is retrieved from biometric action data 410 (step 405). Recipient info 415 includes information about the person to contact such as the recipient's address, contact method, signature flag, and the recipient's public key. For example, if a missing person is found, the local police station dispatcher may be contacted by email as well as by cellular phone. A message may be sent to the dispatcher to send an officer to the scene. A determination is made as to whether to digitally sign the message (decision 420). If the message will be digitally signed, decision 420 branches to “Yes” branch 425 whereupon the message is signed using the sender's private key (step 430). The sender's public key is used by the recipient to authenticate the message is actually sent from the sender. On the other hand, if the message is not to be signed, decision 420 branches to “No” branch 435 bypassing the digital signature step.

A determination is made as to whether the message will be encrypted (decision 440). On the other hand, if the message will be encrypted, decision 440 branches to “Yes” branch 445 whereupon the message is encrypted using the recipient's public key (step 450). The recipient's public key is used to ensure that the recipient is the one that is able to decrypt the message using his private key. On the other hand, if the message will not be encrypted, decision 440 branches to “No” branch 455 bypassing the encryption step. The message is sent to the recipient (step 460) using the contact method described in recipient info 415. A determination is made as to whether there are more recipients to which to send the message (decision 470). If there are more recipients to which to send the message to, decision 470 branches to “Yes” branch 475 which loops back to get the next recipient's information (step 480). This looping continues until there are no more recipients to send the message, at which point decision 470 branches to “No” branch 490 and processing returns at 495.

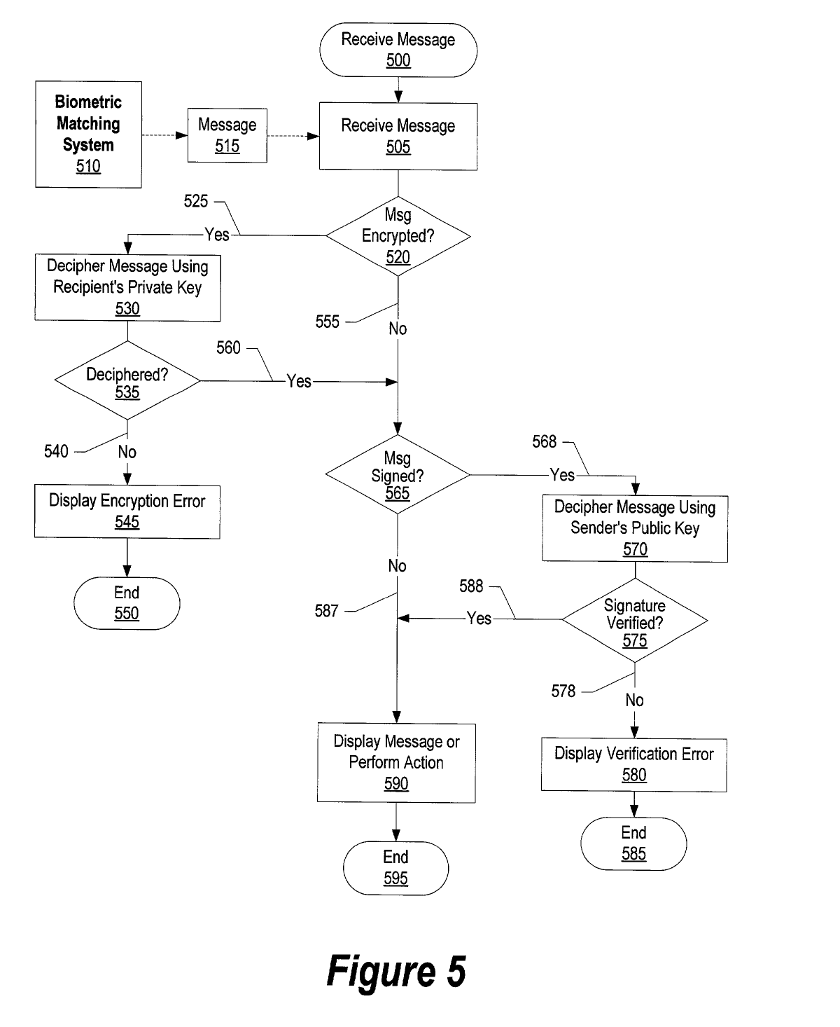

FIG. 5 is a flowchart showing a recipient receiving a message based on the results of the biometric data processing. Processing commences at 500, whereupon message 515 is received from biometric matching system 510 (step 505). A determination is made as to whether the message is encrypted (decision 520). If the message is not encrypted, decision 520 branches to “No” branch 555. On the other hand, if the message is encrypted, decision 520 branches to “Yes” branch 525 whereupon the message is deciphered using the recipients' private key (step 530). Since a message is encrypted using the recipient's public key, the recipient will be the one able to decipher the message using his private key; others will not be able to decipher the message.

A determination is made as to whether the message was deciphered (decision 535). If the message was not deciphered properly using the recipient's private key, the message is not for the recipient and decision 535 branches to “No” branch 540 whereupon a verification error is displayed (step 545) and processing ends at 550. On the other hand, if the message is deciphered properly using the recipient's private key, decision 535 branches to “Yes” branch 560.

A determination is made as to whether the message is digitally signed by the sender (decision 565). If the sender did not sign the message, decision 565 branches to “No” branch 587 whereupon the message is displayed or an action is performed (step 590). On the other hand, if the sender signed the message, decision 565 branches to “Yes” branch 568 whereupon the digital signature is verified using the sender's public key (step 570). Since a signature is performed using the sender's private key, it can be deciphered using the sender's public key. Other public keys will not decipher the signature properly.

A determination is made as to whether the signature is deciphered properly (decision 575). If the signature is not deciphered properly, the message was not sent by the purported sender and decision 575 branches to “No” branch 578 whereupon a verification error message is displayed (step 580), and processing ends at 585. On the other hand, if the signature is deciphered properly using the sender's public key, the signature is verified and decision 575 branches to “Yes” branch 588 whereupon the message is displayed or an action is performed (step 590). For example, if a parolee is in an unauthorized area, a message may be displayed on a parole officer's handheld device informing him that the parolee was identified in an unauthorized area.

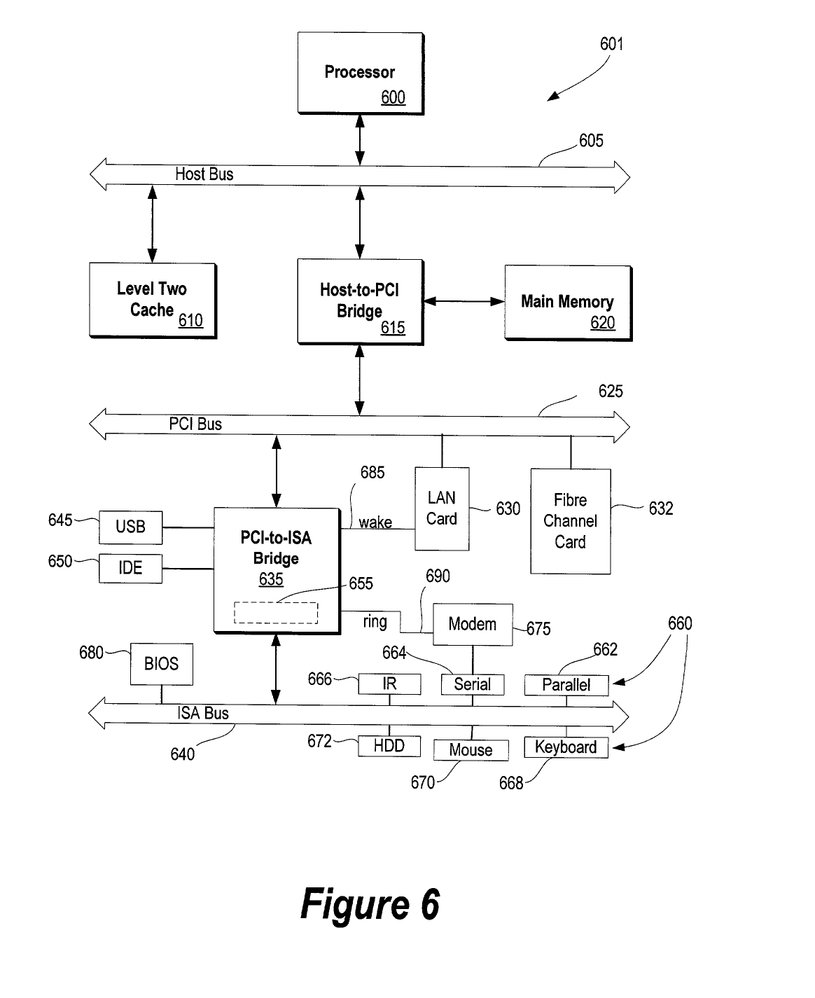

FIG. 6 illustrates information handling system 601 which is a simplified example of a computer system capable of performing the server and client operations described herein. Computer system 601 includes processor 600 which is coupled to host bus 605. A level two (L2) cache memory 610 is also coupled to the host bus 605. Host-to-PCI bridge 615 is coupled to main memory 620, includes cache memory and main memory control functions, and provides bus control to handle transfers among PCI bus 625, processor 600, L2 cache 610, main memory 620, and host bus 605. PCI bus 625 provides an interface for a variety of devices including, for example, LAN card 630. PCI-to-ISA bridge 635 provides bus control to handle transfers between PCI bus 625 and ISA bus 640, universal serial bus (USB) functionality 645, IDE device functionality 650, power management functionality 655, and can include other functional elements not shown, such as a real-time clock (RTC), DMA control, interrupt support, and system management bus support. Peripheral devices and input/output (I/O) devices can be attached to various interfaces 660 (e.g., parallel interface 662, serial interface 664, infrared (IR) interface 666, keyboard interface 668, mouse interface 670, and fixed disk (HDD) 672) coupled to ISA bus 640. Alternatively, many I/O devices can be accommodated by a super I/O controller (not shown) attached to ISA bus 640.

BIOS 680 is coupled to ISA bus 640, and incorporates the necessary processor executable code for a variety of low-level system functions and system boot functions. BIOS 680 can be stored in any computer readable medium, including magnetic storage media, optical storage media, flash memory, random access memory, read only memory, and communications media conveying signals encoding the instructions (e.g., signals from a network). In order to attach computer system 601 to another computer system to copy files over a network, LAN card 630 is coupled to PCI bus 625 and to PCI-to-ISA bridge 635. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of processing a biometric input, said method comprising:
receiving the biometric input from a biometric receiving device;
computing a biometric signature corresponding to the biometric input;
comparing the biometric signature to one or more stored biometric signatures;
determining a match based on the comparing;
identifying an action based on the determination; and
performing the identified action.

2. The method as described in claim 1 wherein the performing further includes:
identifying a message recipient;
preparing a message; and
sending the message to the message recipient.

3. The method as described in claim 2 wherein the preparing further includes:
identifying an encryption key corresponding to the recipient; and
encrypting the message using the identified encryption key.

4. The method as described in claim 2 wherein the preparing further includes:
identifying a sender's digital signature; and
signing the message with the sender's digital signature.

5. The method as described in claim 2 further comprising:
identifying a visual image corresponding to a person, the person corresponding to the biometric signature; and
including the visual image in the message.

6. The method as described in claim 1 wherein the biometric receiving device includes a plurality of biometric receiving devices, each receiving device corresponding to a distinct location id.

7. The method as described in claim 6 further comprising;
identifying a message recipient;
preparing a message;
retrieving a biometric location corresponding to one of the biometric input devices from which the biometric input was received; and
sending a message to the message recipient, wherein the message includes the biometric location.

8. An information handling system comprising:
one or more processors;
a memory accessible by the processors;
one or more nonvolatile storage devices accessible by the processors;
a biometric input handling tool to manage a biometric input stored on one of the nonvolatile storage devices, the biometric input handling tool including:
means for receiving the biometric input from a biometric receiving device;
means for computing a biometric signature corresponding to the biometric input;
means for comparing the biometric signature to one or more stored biometric signatures;
means for determining a match based on the comparing;
means for identifying an action based on the determination; and
means for performing the identified action.

9. The information handling system as described in claim 8 wherein the means for performing further includes:
means for identifying a message recipient;
means for preparing a message; and
means for sending the message to the message recipient.

10. The information handling system as described in claim 9 wherein the means for preparing further includes:
means for identifying an encryption key corresponding to the recipient; and
means for encrypting the message using the identified encryption key.

11. The information handling system as described in claim 9 wherein the means for preparing further includes:
means for identifying a sender's digital signature; and
means for signing the message with the sender's digital signature.

12. The information handling system as described in claim 9 further comprising:
means for identifying a visual image corresponding to a person, the person corresponding to the biometric signature; and
means for including the visual image in the message.

13. The information handling system as described in claim 8 wherein the biometric receiving device includes a plurality of biometric receiving devices, each receiving device corresponding to a distinct location id.

14. The information handling system as described in claim 13 further comprising;
means for identifying a message recipient;
means for preparing a message;
means for retrieving a biometric location corresponding to one of the biometric input devices from which the biometric input was received; and
means for sending a message to the message recipient, wherein the message includes the biometric location.

15. A computer program product stored in a computer operable media for managing a data source, said computer program product comprising:
means for receiving the biometric input from a biometric receiving device;
means for computing a biometric signature corresponding to the biometric input;
means for comparing the biometric signature to one or more stored biometric signatures;
means for determining a match based on the comparing;
means for identifying an action based on the determination; and
means for performing the identified action.

16. The computer program product as described in claim 15 wherein the means for performing further includes:
means for identifying a message recipient;
means for preparing a message; and
means for sending the message to the message recipient.

17. The computer program product as described in claim 16 wherein the means for preparing further includes:
means for identifying an encryption key corresponding to the recipient; and
means for encrypting the message using the identified encryption key.

18. The computer program product as described in claim 16 wherein the means for preparing further includes:
means for identifying a sender's digital signature; and
means for signing the message with the sender's digital signature.

19. The computer program product as described in claim 16 further comprising:
means for identifying a visual image corresponding to a person, the person corresponding to the biometric signature; and
means for including the visual image in the message.

20. The computer program product as described in claim 15 wherein the biometric receiving device includes a plurality of biometric receiving devices, each receiving device corresponding to a distinct location id.

21. The computer program product as described in claim 20 further comprising;
means for identifying a message recipient;
means for preparing a message;
means for retrieving a biometric location corresponding to one of the biometric input devices from which the biometric input was received; and
means for sending a message to the message recipient, wherein the message includes the biometric location.
